(19) United States
(12) Patent Application Publication
(10) Pub. No.: US 2013/0054867 A1
(43) Pub. Date: Feb. 28, 2013

(54) COMMUNICATION APPARATUS AND ID SETTING METHOD

(71) Applicant: Satoru NISHITA, Kahoku (JP)

(72) Inventor: Satoru NISHITA, Kahoku (JP)

(73) Assignee: FUJITSU LIMITED, Kawasaki-shi (JP)

(21) Appl. No.: 13/572,334

(22) Filed: Aug. 10, 2012

(30) Foreign Application Priority Data
Aug. 23, 2011 (JP) 2011-181614

(51) Int. Cl. G06F 13/14

(52) U.S. Cl. 710/316

(57) ABSTRACT

A communication apparatus includes a control device having a conversion device which separates first and second domains being a formation unit of a network using serial connect bus, and which converts a first requester ID which discriminates a root device for generating a packet and which is included in the packet generated in the first domain into a unique second requester ID used in the second domain, and a root device which belongs to the first domain and sets the first requester ID in the conversion device; a switch connected to the second domain side of the conversion device included in the control device; and a root device which belongs to the second domain and sets the second requester ID in the conversion device via the switch.

### CROSS-REFERENCE TO RELATED APPLICATION

This application is based upon and claims the benefit of priority of the prior Japanese Patent Application No. 2011-181614, filed on Aug. 23, 2011, the entire contents of which are incorporated herein by reference.

### FIELD

The embodiment discussed herein is related to a communication apparatus and an ID setting method.

### BACKGROUND

PCI (Peripheral Component Interconnect) Express (hereinafter “PCIe”) is a standard of a bus for connecting devices which was designed by the PCI-SIG (Special Interest Group).

A PCIe bus has a point-to-point topology in which a single device referred to as a root complex is connected to a plurality of devices referred to as end points via ports of a switch.

There is known a storage device which employs a PCIe bus as an interconnect and executes cache mirroring by using inter-controller communications through the interconnect.

See, for example, Japanese Laid-open Patent Publication No. 2009-053946.

There is known an NTB (Non Transparent Bridge) which enables transmission and reception of packets between different buses. The NTB appears as an end point when viewed from the buses on either side of the NTB.

In a storage device in which a plurality of controllers have their own root complex, the topology is closed in each controller. A root complex is capable of setting end points in its own topology, but unable to perform setting of end points outside the topology. Therefore, there is a problem that when a plurality of NTBs are connected by using switches, the setting cannot be performed outside the topology.

The above problem of storage devices also applies to other systems which perform communication by using a PCIe bus.

### SUMMARY

In one aspect of the embodiments, there is provided a communication apparatus. This communication apparatus includes: a plurality of packet transfer devices each including: a conversion device which separates first and second domains being a formation unit of a network using serial connect bus, and which converts a first requester ID which discriminates a device for generating a packet and which is included in the packet generated in the first domain into a unique second requester ID used in the second domain; and a first setting unit which belongs to the first domain and sets the first requester ID in the conversion device; a switch connected to the second domain side of the conversion device included in the plurality of packet transfer devices; and a second setting unit which belongs to the second domain and sets the second requester ID in the conversion device via the switch.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a storage apparatus according to a first embodiment;

FIG. 2 is a block diagram illustrating a storage system according to a second embodiment;

FIG. 3 illustrates read processing of a PCIe bus;

FIG. 4 illustrates a transfer of an I/O request using an NTB;

FIG. 5 is a block diagram illustrating functions of a storage apparatus;

FIG. 6 is a sequence diagram illustrating a process of a storage apparatus during system start-up;

FIG. 7 is a block diagram illustrating functions of a storage apparatus according to a third embodiment; and

FIG. 8 is a sequence diagram illustrating a process at the time of starting up a storage apparatus according to a third embodiment.

### DESCRIPTION OF EMBODIMENTS

Hereinafter, preferred embodiments of the present invention will now be described in detail below with reference to the accompanying drawings, wherein like reference numerals refer to like elements throughout.

### First Embodiment

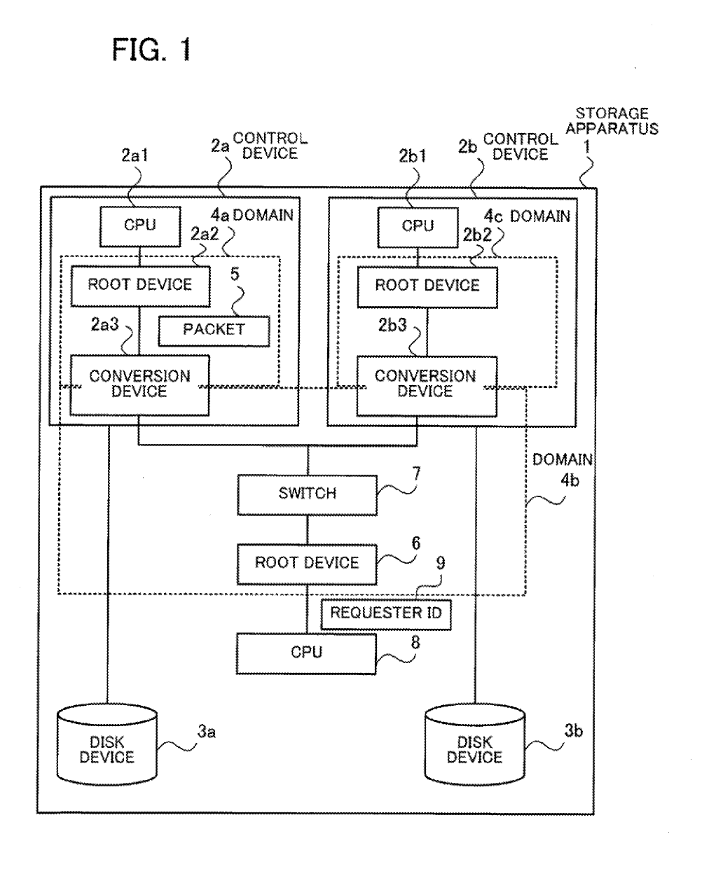

FIG. 1 illustrates a storage apparatus according to a first embodiment.

The storage apparatus 1 according to the first embodiment includes control devices 2a and 2b and disk devices 3a and 3b.

The disk devices 3a and 3b each have storage areas which can store information. Examples of the disk devices 3a and 3b include an HDD (Hard Disk Drive) and an SSD (Solid State Drive).

The control devices 2a and 2b each are one example of a packet transfer device, and are connected via a PCIe bus. The control devices 2a and 2b have the same functions as each other.

The control device 2a has a CPU (Central Processing Unit) 2a1, a root device 2a2, and a conversion device 2a3. Also, the control device 2b has a CPU 2b1, a root device 2b2, and a conversion device 2b3. Hereinafter, functions of the control device 2a will be described on behalf thereof.

The control device 2a writes data received from a host device (not illustrated) in the disk device 3a, or reads out data stored in the disk device 3a. Through the process, the control device 2a controls the disk device 3a.

The CPU 2a1 manages a process of the control device 2a.

The root device 2a2 is one example of a first setting unit, and a device as an essential part of a domain (a unit of managing a PCIe) 4a provided in the control device 2a. The control device 2a adopts a tree structure in which the root device 2a2 is arranged as a top in the domain 4a. The root device 2a2 has one or a plurality of PCIe ports. The root device 2a2 outputs a packet 5 including an ID (requester ID) of the root device 2a2 which requests readout of data to be read via a PCIe bus. The requester ID included in the packet 5 is one example of a first requester ID, and includes a number for identifying the root device 2a2 and a bus number for each port of the root device 2a2.

The conversion device 2a3 is a device which is positioned at the lower rank of the root device 2a2, and provided in a border of the domain 4a. This conversion device 2a3 is an I/O (Input/Output) device recognized as a terminating set (end point) independent from each of the root devices 2a2 and 6. Specifically, the conversion device 2a3 functions as a bridge which separates an interior portion and exterior portion of the domain 4a, and converts the requester ID of the packet 5 received from the interior portion of the domain 4a into the unique requester ID used in the domain 4b outside the domain 4a. The conversion device 2a3 further converts the requester ID of the packet received from the domain 4b into the unique requester ID used in the domain 4a.

The packet 5 produced from the conversion device 2a3 of the domain 4a is sent to the conversion device 2b3. The conversion device 2b3 converts the requester ID included in the received packet 5 into the unique requester ID used in the domain 4c.

The domain 4b adopts a tree structure in which the root device 6 is arranged as a top and which is one example of a second setting unit. A switch 7 is a device which is positioned at the lower rank of the root device 6, and is an FRT (Front-end Router) which connects the conversion devices 2a3 and 2b3. At the time of starting up the storage apparatus 1, for example, the root device 6 supplies the requester ID 9 generated by the CPU 8 to the conversion devices 2a3 and 2b3 via the switch 7. The requester ID 9 is one example of the second requester ID. When receiving the requester ID 9, the conversion devices 2a3 and 2b3 store the received requester ID 9. During the conversion of the requester ID included in the packet 5, the conversion devices 2a3 and 2b3 convert the requester ID included in the packet 5 by using the stored requester ID 9.

This storage apparatus 1 issues the requester ID 9 to the end points of the domain 4b side of the conversion devices 2a3 and 2b3. When issuing the requester ID 9, the storage apparatus 1 sets a bus number and a device number to the end points of the domain 4b side of the conversion devices 2a3 and 2b3. When the bus number and the device number are set to the end points of the domain 4b side of the conversion devices 2a3 and 2b3, the conversion devices 2a3 and 2b3 perform the conversion of the requester ID. When performing the conversion of the requester ID, the conversion devices 2a3 and 2b3 perform intermediation of the packet 5 which requests readout of the data to be read over the domains 4a and 4b.

A situation of transferring the packet 5 is not particularly limited thereto; further, for example, the packet 5 may be transferred under the following situation.

The read request of data in the PCIe bus is determined so as to send back a completion notification with data. For this purpose, when receiving the completion notification with data, the output side of the request to be read grasps completion of the data transfer. Accordingly, when the PCIe bus is set so as not to overtake the transaction on the same bus, the read request exerts an effect of pushing out a write request on the bus. Accordingly, for example, after supplying the write request of certain data to the control device 2b, the control device 2a supplies the read request of the data and receives the completion notification with data with respect to the read request. As a result, the control device 2a grasps that data is correctly written in the control device 2b.

In the present embodiment, the embodiment in which the disclosed technology is applied to the storage apparatus 1 is described. An application field for the disclosed technology is not limited to a storage apparatus.

In the present embodiment, the apparatus using the PCIe bus is described as one example of the apparatus. Also, the disclosed technology is applied also to other apparatus including an I/O device which receives the bus number and the device number and recognizes both the numbers allocated to its own device.

Hereinafter, in a second embodiment, the disclosed storage apparatus will be more specifically described.

### Second Embodiment

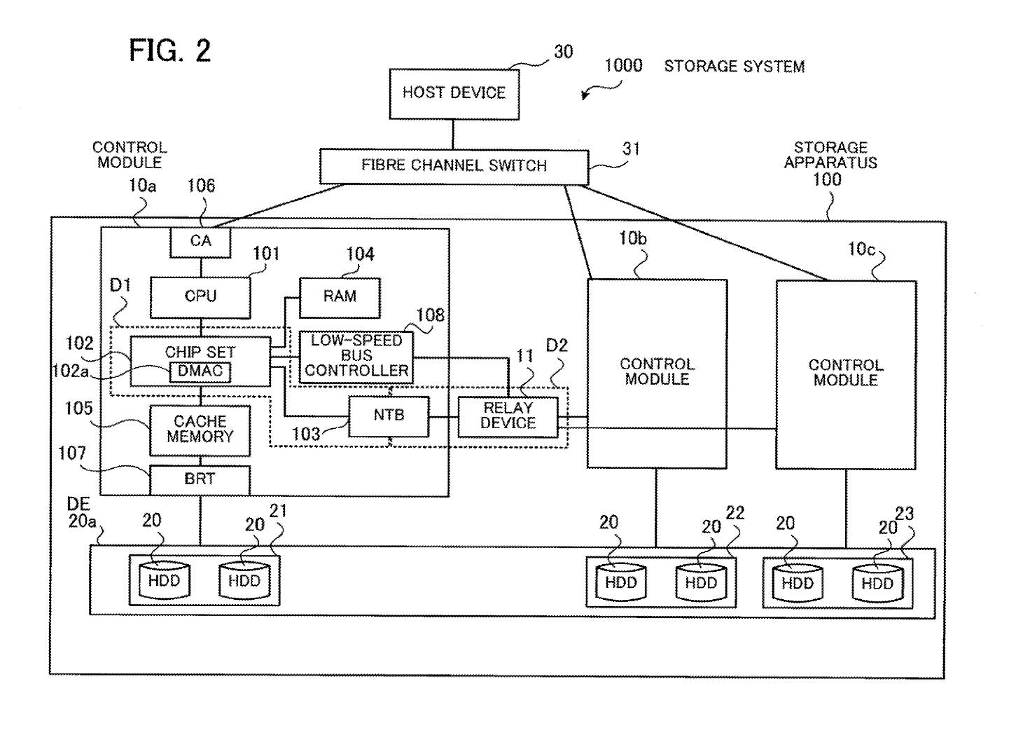

FIG. 2 is a block diagram illustrating a storage system according to a second embodiment.

The storage system 1000 includes a host device 30 and a storage apparatus 100 connected to this host device 30 via an FC (Fibre Channel) switch 31. In FIG. 2, one host device 30 is connected to the storage apparatus 100, and further a plurality of host devices may be connected to the storage apparatus 100.

The storage apparatus 100 includes a DE (Drive Enclosure) 20a each having a plurality of HDDs 20, and CMs (Controller Module) 10a, 10b, and 10c which manages a physical storage area of this DE 20a by using RAID (Redundant Arrays of Inexpensive/Independent Disks). In the present embodiment, a storage medium included in the DE 20a is described with reference to the HDD 20. However, it is not limited to the HDD 20, and other storage media such as an SSD may be used. Hereinafter, in the case where the plurality of the HDDs 20 included in the DE 20a are not differentiated, they are referred to as an “HDD 20 group”. A total capacity of the HDD 20 group is, for example, from 600 GB (Giga Byte) to 240 TB (Tera Byte).

In the storage apparatus 100, when three control modules 10a, 10b, and 10c are used for operation, redundancy is secured. Note that the number of the control modules included in the storage apparatus 100 is not limited to three and further the redundancy may be secured by using two, or four or more control modules.

The control modules 10a, 10b, and 10c are connected through a relay device 11 by the PCIe bus.

The control modules 10a, 10b, and 10c are one example of the control device, respectively, and the control modules 10a, 10b, and 10c are realized by using the same hardware configuration as each other.

According to a data access request from the host device 30, the control modules 10a, 10b, and 10c control a data access to the physical storage area of the HDD 20 included in the DE 20a by using the RAID, respectively.

Since the control modules 10a, 10b, and 10c are realized by using the same hardware configuration, respectively, the hardware configuration of the control module 10a will be described on behalf thereof.

The control module 10a has a CPU 101, a chip set 102, an NTB (Non-Transparent Bridge) 103, a RAM (Random Access Memory) 104, a cache memory 105, a CA (Channel Adapter) 106, a BRT (Back end RouTer) 107, and a low-speed bus controller 108.

When executing a program stored in a flash ROM (Read Only Memory) (not illustrated) included in the control module 10a, the CPU 101 collectively controls the entire control module 10a. The chip set 102 has functions of a Root Complex of the PCIe. To this chip set 102, the NTB 103, the RAM 104, the cache memory 105, and the low-speed bus controller 108 are connected.

In each of the control modules 10a, 10b, and 10c, there is formed a domain in which devices of a PCIe are constituted with the root complex arranged as a top. In one domain, one or a plurality of end points (I/O device of the PCIe) are provided at the lower rank of one root complex as a top. Between the root complex and the end point, a switch for increasing a PCIe port may be further provided. In FIG. 2, the domains D1 and D2 in which the NTB 103 is positioned as a border are illustrated. The domain D1 is one example of a first domain, and the domain D2 is one example of a second domain. In the chip set 102 and chip sets included in the control modules 10b and 10c, a DMA (Direct Memory Access) controller 102a is provided, respectively. Note that the DMA controller 102a may be provided on a portion other than the chip set 102 of the control module 10a.

The control module 10a transmits and receives a packet between the PCIe buses by using the DMA function included in the DMA controller 102a. For example, the transmission and reception of the packet between the control modules 10a and 10b is performed via the DMA controller 102a, the NTB 103, the relay device 11, the NTB included in the control module 10b, and the DMA controller included in the control module 10b. For example, when the packet for performing a write request in the HDD 20 group is transmitted from the host device 30 to the control module 10a via the fibre channel switch 31, the CPU 101 stores the received packet in the cache memory 105. Along with the storage of the packet, the CPU 101 transmits the received packet to the control module 10b via the relay device 11. The control module 10b then stores the packet received by the CPU of the control module 10b in the cache memory of the control module 10b. Through the process, the same packet is stored in the cache memory 105 of the control module 10a and the cache memory of the control module 10b.

The NTB 103 has functions of each end point of the domains D1 and D2. Specifically, the NTB 103 allows two PCIe buses to be connected, and two domains of respective PCIe buses to be separated and electrically connected. As a device interface, this NTB 103 appears as an end point when viewed from the PCIe buses. When the NTB 103 is arranged in the control module 10a, the packet can be transmitted and received over the NTB 103, namely, over the domain.

The RAM 104 temporarily stores at least a part of a program executed by the CPU 101 and various data necessary for a processing due to the program.

The cache memory 105 temporarily stores data written in the HDD 20 group and data read out from the HDD group. In the cache memory 105, data necessary for processing through the CPU 101 may be temporarily stored. Examples of the cache memory 105 include a volatile semiconductor device such as an SRAM (Static Random Access Memory). A storage capacity of the cache memory 105 is not particularly limited, and approximately from 2 to 64 GB as one example.

The channel adapter 106 is connected to the fibre channel switch 31, and further connected to a channel of the host device 30 via the fibre channel switch 31. The channel adapter 106 provides an interface function of transmitting and receiving data between the host device 30 and the control module 10a.

The BRT 107 is connected to the DE 20a. This BRT 107 provides an interface function of transmitting and receiving data between the cache memory 105 and the HDD 20 group included in the DE 20a. Via the BRT 107, the control module 10a transmits and receives data between its own module and the HDD 20 group included in the DE 20a.

The low-speed bus controller 108 controls a bus with a speed lower than a data transfer speed of the PCIe bus. At the time of starting up the control module 10a, the chip set 102 exchanges setting information for setting the NTB 103 between its own set and the relay device 11 via the low-speed bus controller 108.

In the DE 20a, among a plurality of the HDDs 20 included in the DE 20a, a RAID group constituted by one or the plurality of the HDDs 20 is formed. This RAID group may be referred to as a “virtual disk”, or an “RLU (RAID Logical Unit)”.

In FIG. 2, three RAID groups 21, 22, and 23 each constituting a RAID 5 are illustrated. Note that the RAID configuration of the RAID group 21 is one example, and not limited to the RAID configuration illustrated in the drawing. For example, the RAID groups 21, 22, and 23 each have the arbitrary number of the HDDs 20. The RAID groups 21, 22, and 23 may be constituted by using an arbitrary RAID method such as a RAID 6.

In the RAID group 21, for example, logical volumes into which a memory area of the HDDs 20 constituting the RAID group 21 is logically divided are constituted. In each of the divided logical volumes, an LUN (Logical Unit Number) is set.

In the storage apparatus 100 having a hardware configuration as illustrated in FIG. 2, the following functions are provided.

In the case where a packet communication between the control modules 10a, 10b, and 10c fails due to a route of the PCIe bus, they perform recovery processing for communication. For performing the recovery processing for communication, the control module starting up communication performs a process of grasping a communication result in a command unit.

In terms of regulations of the PCIe bus, a write request is posted, and no write completion notification is sent back from an object device for transmitting the write request. For that purpose, even if a packet to be communicated disappears between the control modules and the control module detects that an error is caused by a switch on the communication route, the control module fails to identify that the error is an error caused by any of the commands. Therefore, the control module which transmits the write request fails to detect a failure in the communication.

As compared with the above, since a completion notification with data is sent back with respect to a read request in the PCIe bus, a completion of the data transfer is assured. When a read request is set so as not to overtake the transaction on the same bus, the read request exerts an effect of pushing out a write request. Accordingly, when receiving a read completion notification, the control module starting up communication assures a write completion. Further, when failing to receive the read completion notification, the control modules 10a, 10b, and 10c immediately grasp a failure in the write.

Hereinafter, read processing of the PCIe bus will be described.

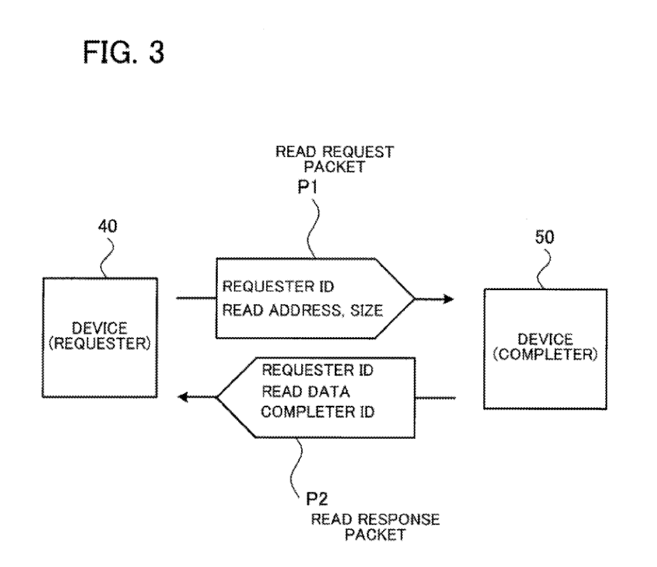

FIG. 3 illustrates the read processing of the PCIe bus.

FIG. 3 illustrates a data transfer from the device 40 to the device 50 at the time when the device 40 is set as a requester, and the device 50 is set as a completer. When requesting readout of data from the device 50, a read request packet P1 issued by the device 40 includes an ID (requester ID) of the device 40. The device 50 identifies the device 40 as a response destination based on the requester ID included in the read request packet P1. The device 50 then transmits a read response packet P2 to the identified device 40 as a response destination. The read response packet P2 includes the requester ID and read data of the device 40, and the ID (completer ID) of the device 50. The read data is data read out from a storage area not illustrated by the device 50 according to the read request packet P1.

Next, a generation method of the requester ID will be described. In terms of the regulations of the PCIe, when a BIOS (Basic Input/Output System) is initialized, the devices 40 and 50 grasp the bus number and device number included in the packet of a configuration write to be issued to their own devices. The device 40 grasps the bus number and device number of its own device. The device 40 generates the requester ID based on the grasped bus number and device number.

When performing a process illustrated in FIG. 3, for example, as compared with a case of implementing a special communication device including a function of sending back a reception result of data in the control module, manufacturing cost of each control module is made inexpensive. In all transactions which never permit overtaking, the same PCIe bus is used. When an “enable relaxed ordering” bit of a device control register of the PCIe is set to be disable, the above is realized.

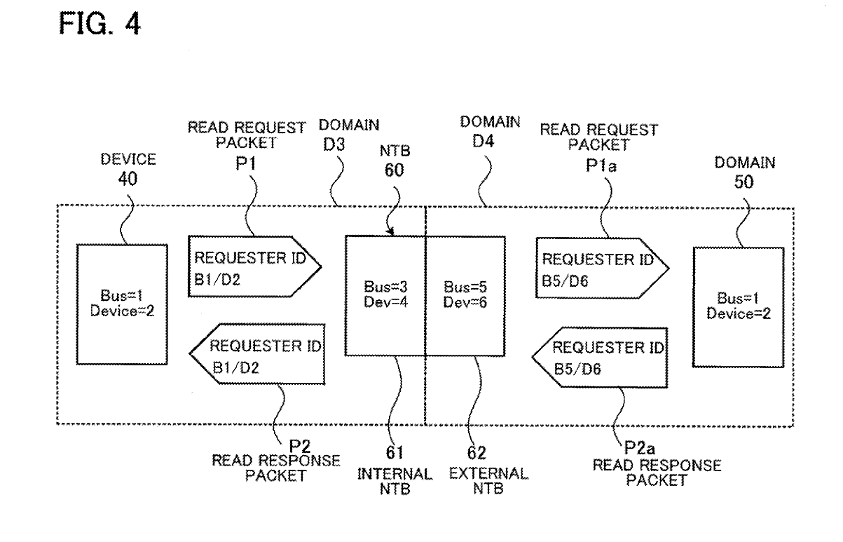

Next, a transfer of an I/O request using the NTB for a device illustrated in FIG. 4 will be described.

FIG. 4 illustrates a transfer of the I/O request using the NTB.

In FIG. 4, there are set a domain D3 in which the device 40 is arranged as a top and a domain D4 in which the device 50 is arranged as a top. An NTB 60 is further installed between the domains D3 and D4.

When the device 40 issues a read request to the device 50, in the case where a device having the same ID as the requester ID of the read request packet P1 is present in the domain D4 of the partner side, the read request packet P1 fails to return to its own domain D3. To cope with the problem, the NTB 60 uniquely sets the requester ID in each of the domains D3 and D4. Specifically, the NTB 60 is viewed as if end point devices independent from each other are present in both domain sides. In FIG. 4, a portion of the NTB 60 viewed as if the end point device of the domain D3 side is present is referred to as an “internal NTB 61”. On the other hand, a portion of the NTB 60 viewed as if the end point device of the domain D4 side is present is referred to as an “external NTB 62”.

In the internal NTB 61, there is previously set information (the bus number and the device number) in which a read request packet (not illustrated in FIG. 4) received from the domain D4 side is converted into an ID of the end point of the domain D3 side. Also, in the external NTB 62, there is previously set information (the bus number and the device number) in which a read request packet P1 received from the domain D3 side is converted into an ID of the end point of the domain D4 side.

For example, since the read request packet P1 is a packet issued to the outside of the domain D3 by the device 40, when receiving the read request packet P1, the external NTB 62 converts the requester ID (B1/D2) included in the read request packet P1 into the requester ID (B5/D6) of the end point of the domain D4 side. In a storage unit (not illustrated) of the NTB 60, the NTB 60 stores information (hereinafter, referred to as “conversion data”) indicating that the requester ID (B1/D2) included in the read request packet P1 is converted into the requester ID (B5/D6). The external NTB 62 then transfers a read request packet P1a including the converted ID to the device 50. Through the process, the external NTB 62 implements an intermediation of the read request over the domains D3 and D4.

The device 50 issues a read response packet P2a according to the read request packet P1a. When receiving the read response packet P2a, the internal NTB 61 converts the requester ID (B5/D6) included in the read response packet P2a into the requester ID (B1/D2) of the end point of the domain D3 side with reference to the conversion data. When then transferring the read response packet P2 including the converted requester ID to the device 40, the internal NTB 61 implements an intermediation of the read response over the domains D3 and D4.

Incidentally, as described above, at the time of performing the conversion of the requester ID, the bus number and device number set in the internal NTB 61 and the external NTB 62 are used. When the bus number and the device number are supposed to be not set, the requester ID of the packet obtained by converting the requester ID has an unreasonable value. The internal NTB 61 fails to send back the read response packet P2a to the device 40.

Hereinafter, a method for setting the conversion data of the storage apparatus 100 will be described.

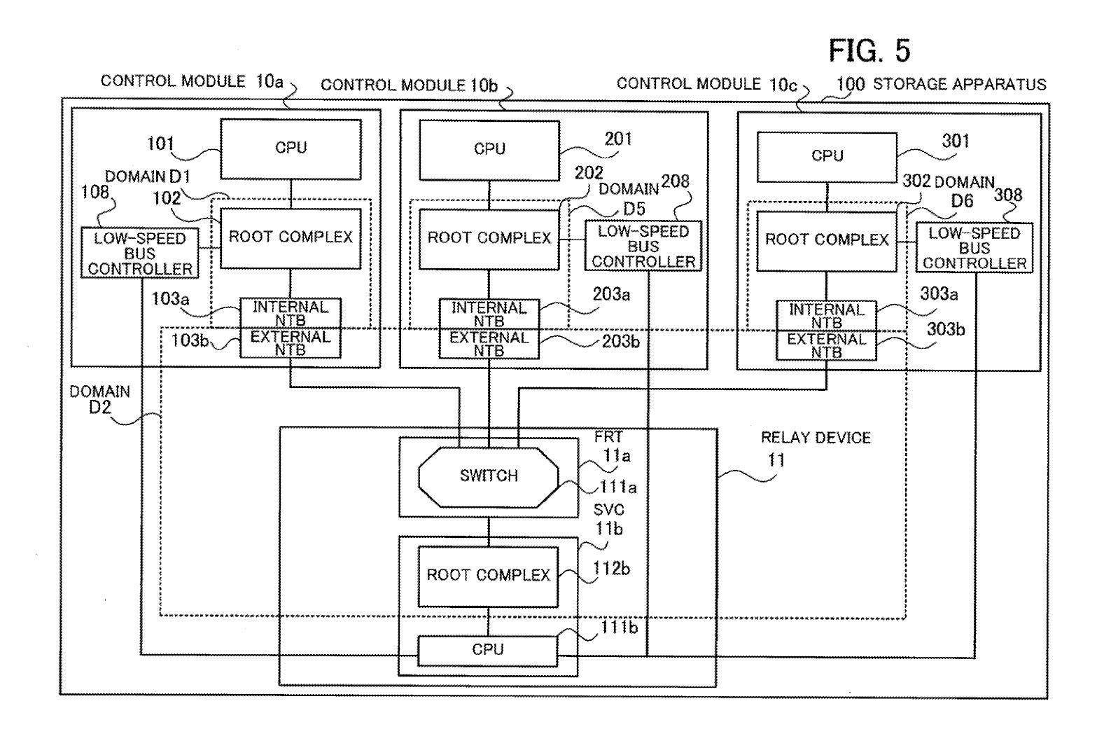

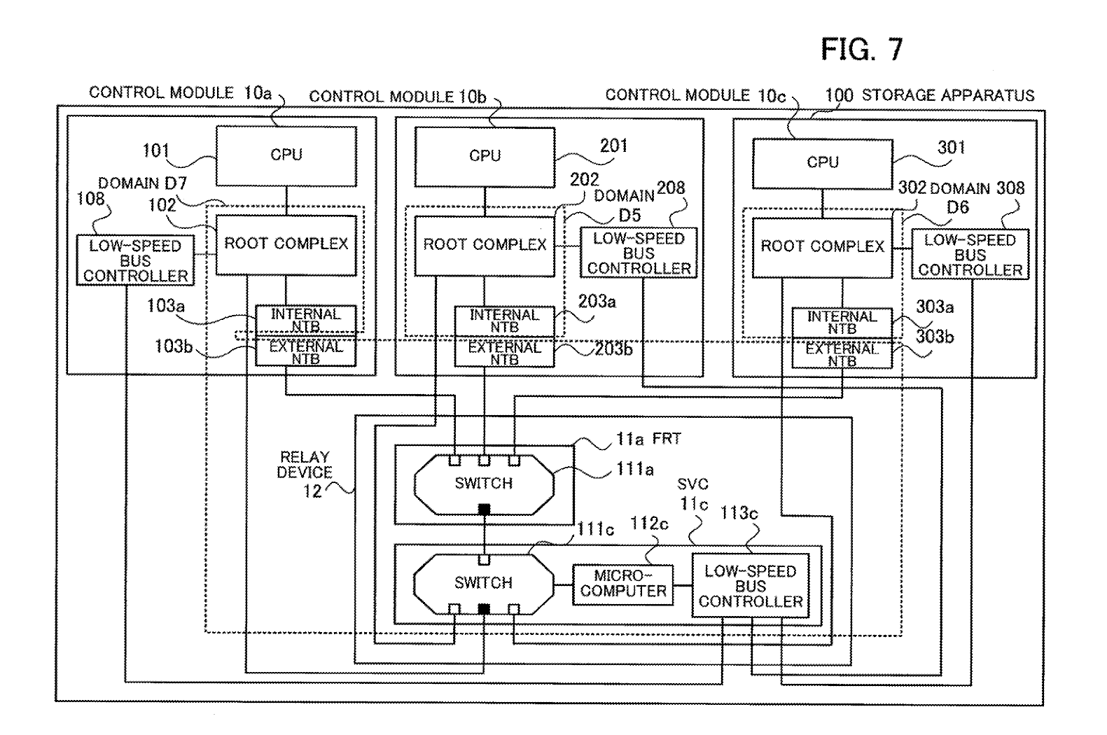

FIG. 5 is a block diagram illustrating functions of the storage apparatus. In FIG. 5, the chip sets 102, 202, and 302 are described as the root complex. Much the same is true on FIG. 7 hereinafter described.

The relay device 11 has an FRT 11a and an SVC (Service Controller) 11b.

The FRT 11a is a PCIe switch, and connects the control modules 10a, 10b, and 10c to each other.

The SVC 11b has a CPU 111b and a root complex 112b. The CPU 111b collectively controls the entire relay device 11. The CPU 111b issues configuration write including each conversion data of the external NTBs 103b, 203b, and 303b to their own NTBs of the control modules 10a, 10b, and 10c.

The root complex 112b is a device as an essential part of the domain D2.

Next, processing of the storage apparatus 100 during system start-up will be described.

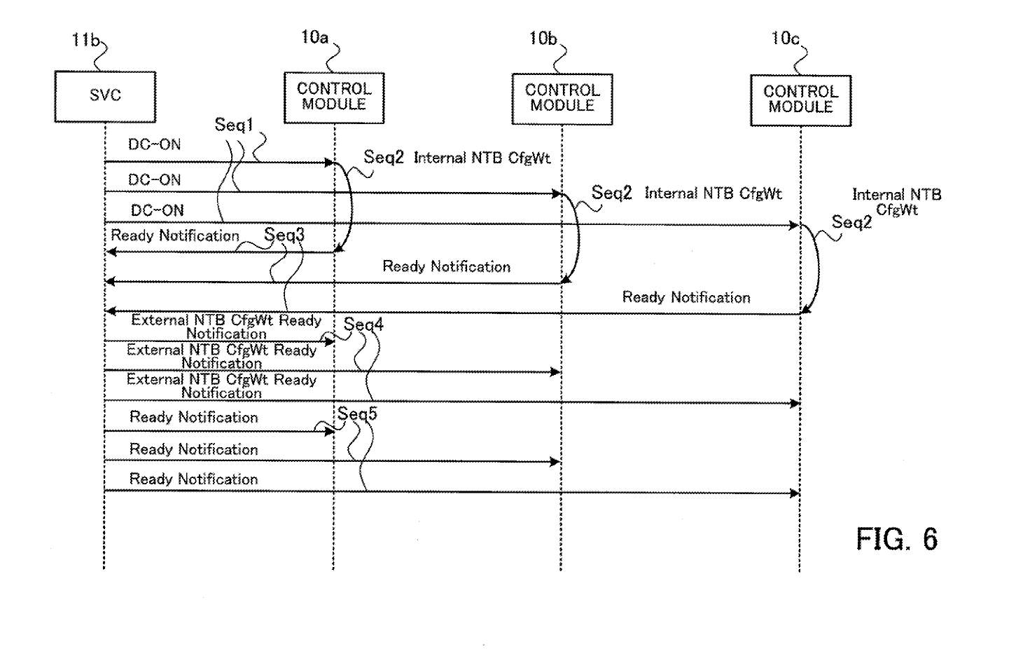

FIG. 6 is a sequence diagram illustrating processing of the storage apparatus during the system start-up.

(Sequence Seq1) The SVC 11b permits control power from power supply to be supplied to the control modules 10a, 10b, and 10c.

(Sequence Seq2) In the control modules 10a, 10b, and 10c to which the control power is supplied, the CPUs 101, 201, and 301 issue the configuration write (in FIG. 6, it is described as “CfgWt”) including the bus number and the device number. The root complexes 102, 202, and 302 set the bus number and the device number based on the configuration write in the internal NTBs 103a, 203a, and 303a, respectively.

(Sequence Seq3) The root complexes 102, 202, and 302 transmit Ready notifications to the CPU 111b via the low-speed bus controllers 108, 208, and 308, respectively.

(Sequence Seq4) The CPU 111b issues the configuration write to the external NTBs 103b, 203b, and 303b of the domains in the control modules 10a, 10b, and 10c which transmit the Ready notifications. The root complex 112b sets the bus number and the device number based on the configuration write in the external NTBs 103b, 203b, and 303b via the switch 111a. Thereafter, the control modules 10a, 10b, and 10c wait for the Ready notifications from the SVC 11b.

(Sequence Seq5) When the SVC 11b transmits the Ready notifications to the control modules 10a, 10b, and 10c, a data access using a DMA function is attained among the control modules 10a, 10b, and 10c.

According to the storage apparatus 100, as described above, the root complex 112b different from the root complexes 102, 202, and 302 is provided on the domain D2. To the external NTBs 103b, 203b, and 303b, the configuration write is further issued. The issuance of the configuration write permits the bus number and the device number to be set in the external NTBs 103b, 203b, and 303b. When the bus number and the device number are set in the external NTBs 103b, 203b, and 303b, the external NTBs 103b, 203b, and 303b perform the conversion of the requester ID. When the external NTBs 103b, 203b, and 303b perform the conversion of the requester ID, the NTBs 103, 203, and 303 implement the intermediation of the read request over the domains.

### Third Embodiment

Next, a storage system according to a third embodiment will be described.

Hereinafter, the storage system according to the third embodiment will be described with a focus on a difference from the above-described second embodiment. Relating to the same matters, their descriptions will not be repeated.

FIG. 7 is a block diagram illustrating functions of the storage apparatus according to the third embodiment.

The storage apparatus 100a according to the third embodiment illustrated in FIG. 7 differs from the storage apparatus 100 according to the second embodiment in a configuration of a relay device and a structured domain.

The storage apparatus 100a has a configuration in which a PCIe bus for issuing the configuration write is routed to the external NTBs 203b and 303b of respective control modules 10b and 10c via the FRT 11a from the root complex 102 of the control module 10a. Accordingly, the root complex 102 and NTB 103 of the control module 10a and the relay device 12 belong to the same domain D7.

The relay device 12 has a switch 111c connected to the root complexes 102, 202, and 302 of the respective control modules 10a, 10b, and 10c, a microcomputer 112c, and a low-speed bus controller 113c.

Ports of the switch 111c are divided into an upstream port and a downstream port. A port near to the root complex is referred to as the upstream port, and all ports except the upstream port are referred to as the downstream ports.

The microcomputer 112c sets any one of the control modules 10a, 10b, and 10c as a master based on a previously set setting reference. On the other hand, the microcomputer 112c sets as slaves the control modules except the control module set as the master. In the present embodiment, the microcomputer 112c sets the control module 10a as the master and the control modules 10b and 10c as the slaves. The control module 10a set as the master is one example of a second packet transfer device. The control modules 10b and 10c set as the slaves are one example of a first packet transfer device. The microcomputer 112c connects the root complex 102 of the control modules 10a set as the master to the upstream port of the switch 111c. The microcomputer 112c further connects chip sets of the control modules 10b and 10c to the downstream ports of the switch 111c. Note that it is preferred that the ports of the switch 111c to which the control modules 10b and 10c are connected are electrically disconnected. Through the process, an erroneous access from the control modules 10b and 10c to the switch 111a is controlled.

In the case where communication using the control module 10a fails to be performed due to a failure in the control module 10a, the microcomputer 112c resets the switch 111c, sets any of the control modules 10b and 10c as the master, and changes the upstream port. The process permits the storage apparatus 100a to be operated without stopping its own apparatus.

The low-speed bus controller 113c is connected to the low-speed bus controllers 108, 208, and 308.

Next, a process at the time of starting up the storage apparatus 100a according to the third embodiment will be described.

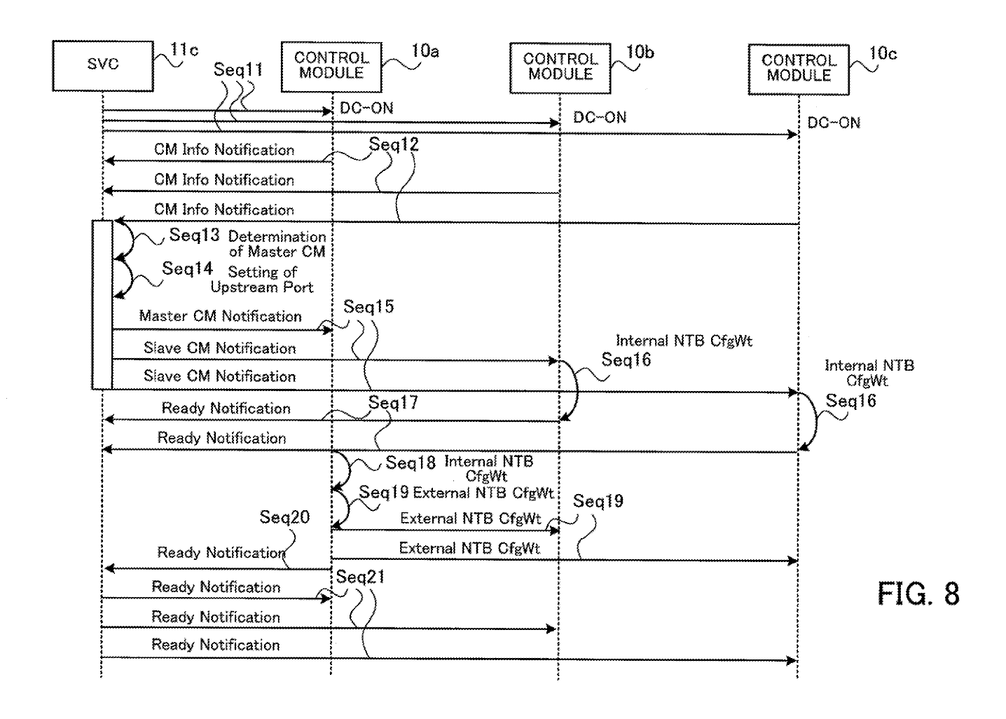

FIG. 8 is a sequence diagram illustrating a process at the time of starting up the storage apparatus according to the third embodiment.

(Sequence Seq11) The SVC 11c permits control power from power supply to be supplied to the control modules 10a, 10b, and 10c.

(Sequence Seq12) The control modules 10a, 10b, and 10c to which the control power is supplied notify the SVC 11c of information on their own modules via the low-speed bus controllers 108, 208, and 308.

(Sequence Seq13) Based on the information notified at Sequence Seq12, the SVC 11c determines the control module 10a as the master in the present embodiment.

(Sequence Seq14) The microcomputer 112c sets the upstream port of the switch 111c to a port connected to the root complex 102 of the control module 10a.

(Sequence Seq15) The microcomputer 112c notifies the control module 10a set as the master that the control module 10a is the master. On the other hand, the microcomputer 112c notifies the control modules 10b and 10c except the control module 10a set as the master that the control modules 10b and 10c are the slaves.

(Sequence Seq16) The control modules 10b and 10c notified that their own modules are the slaves start an initialization of the internal NTBs 203a and 303a. Specifically, the CPUs 201 and 301 issue the configuration write including the bus number and the device number. The root complexes 202 and 302 set the bus number and the device number in the internal NTBs 203a and 303a based on the configuration write, respectively.

(Sequence Seq17) When the setting of the bus number and the device number is completed, the root complexes 202 and 203 transmit Ready notifications to the low-speed bus controller 113c via the low-speed bus controllers 208 and 308. The microcomputer 112c grasps the reception of the Ready notification via the low-speed bus controller 113c.

(Sequence Seq18) On the other hand, the control module 10a notified that its own module is the master starts an initialization of the internal NTB 103a. Specifically, the CPU 101 issues the configuration write including the bus number and the device number. The root complex 102 sets the bus number and the device number in the internal NTB 103a based on the configuration write.

(Sequence Seq19) The control module 10a starts an initialization of the external NTBs 103b, 203b, and 303b. Specifically, the CPU 101 issues the configuration write including the bus number and the device number. The root complex 102 sets the bus number and the device number in the external NTBs 103b, 203b, and 303b via the switches 111c and 111a.

(Sequence Seq20) When completing the setting of the bus number and the device number, the root complex 102 transmits the Ready notification to the low-speed bus controller 113c via the low-speed bus controller 108. The microcomputer 112c grasps the reception of the Ready notification via the low-speed bus controller 113c.

(Sequence Seq21) When grasping the reception of the Ready notification via the low-speed bus controller 113c, the microcomputer 112c transmits the Ready notification to the control modules 10a, 10b, and 10c. Subsequently, the data access using a DMA function is attained among the control modules 10a, 10b, and 10c.

The storage system according to the third embodiment exerts the same effect as that of the storage system of the second embodiment.

According to the storage system of the third embodiment, when the SVC 11 is further replaced by the SVC 11c, one root complex is saved and cost of the storage system is reduced.

With this, while the communication apparatus and the ID setting method of the present invention are described based on the embodiments illustrated in the drawings, the embodiments of the present invention are not limited thereto; the configurations of the components may be replaced by any other configurations having the same functions. In addition, other arbitrary components or processes may be added to the present invention.

Further, in the present invention, two or more arbitrary configurations (characteristics) may be combined among the above-described embodiments.

The above-described processing functions can be realized with a computer. In that case, programs are provided which describe contents of the processing functions to be executed by the control devices 2a and 2b, and the control modules 10a, 10b, and 10c. By causing the computer to execute the programs, the above-described processing functions are realized on the computer. The programs describing the contents of the processing functions can be recorded on a computer-readable recording medium. The computer-readable recording medium includes a magnetic storage device, an optical disk, a magneto-optical recording medium, and a semiconductor memory. The magnetic storage device includes a hard disk drive, an FD (flexible disk), and a magnetic tape. The optical disk includes a DVD, a DVD-RAM, and a CD-ROM/RW. The magneto-optical recording medium includes an MO (magneto-optical disk).

When the programs are circulated on markets, for example, a portable recording medium, such as a DVD or a CD-ROM, recording the programs is commercialized for sale. The programs can also be circulated by storing the programs in a memory device of a server computer, and by transferring the stored programs from the server computer to other computers via a network.

The computer for executing the programs stores the programs recorded on the portable recording medium or the programs transferred from the server computer in its own memory device, for example. The computer reads the programs from its own memory device and executes processing in accordance with the programs. Alternatively, the computer can execute processing in accordance with the programs by directly reading the programs from the portable recording medium. The computer may also execute processing in such a way that, whenever part of the programs are transferred from the server computer connected via a network, the computer sequentially executes processing in accordance with the received program.

Also, at least part of the above-described processing functions may be realized with an electronic circuit, such as a DSP (digital signal processor), an ASIC (application specific integrated circuit), or a PLD (programmable logic device).

According to one embodiment, setting can be performed outside topology of NTB.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A communication apparatus comprising:
a plurality of packet transfer devices each including:
a conversion device which separates first and second domains being a formation unit of a network using serial connect bus, and which converts a first requester ID which discriminates a device for generating a packet and which is included in the packet generated in the first domain into a unique second requester ID used in the second domain; and
a first setting unit which belongs to the first domain and sets the first requester ID in the conversion device;
a switch connected to the second domain side of the conversion device included in the plurality of packet transfer devices; and
a second setting unit which belongs to the second domain and sets the second requester ID in the conversion device via the switch.

2. The communication apparatus according to claim 1, wherein the second setting unit sets the second requester ID issued by a CPU, outside the second domain, connected to the second setting unit in the conversion device.

3. A communication apparatus comprising:
at least one first packet transfer device including:
a conversion device which separates first and second domains being a formation unit of a network using serial connect bus, and which converts a first requestor ID included in a packet generated in the first domain into a unique second requester ID used in the second domain; and
a first setting unit which belongs to the first domain and sets the first requester ID in the conversion device; and
a second packet transfer device including:
a switch which belongs to the second domain and is connected to the second domain side of the conversion device; and
a second setting unit which sets the first and second requester IDs in the conversion device via the switch.

4. The communication apparatus according to claim 3, wherein:
the first packet transfer devices is provided in plurality; and
the communication apparatus further comprises a selection unit which selects the first packet transfer device to be used in place of the second packet transfer device at the time of a failure in the second packet transfer device.

5. The communication apparatus according to claim 4, wherein:
the selection unit selects one packet transfer device as the second packet transfer device from among a plurality of packet transfer devices each including the conversion device and the first setting unit, sets the second setting unit included in the selected second packet transfer device to an upstream port, and manages a switch which sets the switch and the first setting unit included in the first packet transfer device to a downstream port; and
the selection unit sets a port of the first packet transfer device to be used in place of the second packet transfer device to the upstream port at the time of a failure in the second packet transfer device.

6. An ID setting method for use in a plurality of conversion devices which separate first and second domains being a formation unit of a network using a serial connect bus, and which convert a first requester ID which discriminates a device for generating a packet and which is included in the packet generated in the first domain into a unique second requester ID used in the second domain, the ID setting method comprising:
setting, by a first setting unit belonging to the first domain, the first requester ID in the conversion device; and
setting, by a second setting unit belonging to the second domain, the second requester ID in the conversion device via a switch connected to the second domain side of the plurality of conversion devices.
